(19) United States
(12) Patent Application Publication
(10) Pub. No.: US 2022/0260208 A1
(43) Pub. Date: Aug. 18, 2022

(54) OVERPRESSURE RELIEF SYSTEM

(71) Applicant: Anderson Group, Ltd., Waterville, OH (US)

(72) Inventor: Douglas Michael, Swanton, OH (US)

(21) Appl. No.: 17/670,966

(22) Filed: Feb. 14, 2022

Related U.S. Application Data
(60) Provisional application No. 63/148,845, filed on Feb. 12, 2021.
(60) Provisional application No. 63/157,052, filed on Mar. 5, 2021.

(51) Int. Cl. F17C 3/12; F17C 13/04

(52) U.S. Cl. CPC F17C 3/12; F17C 13/04; F17C 2260/042; F17C 2223/0123; F17C 2205/0332

(57) ABSTRACT

The present disclosure concerns an overpressure relief system that can be affixed to an enclosed vessel and provide an exhaust therein if the pressure exceeds a prescribed amount. The system functions by selection of a moveable weight that covers a pressure relief channel in connection with the vessel. As pressure passes a threshold, the weight is shifted upwards within the system, allowing the pressure relief channel to connect to an outlet. Overpressure may then be relieved through the outlet and the weight returns to close access to the outlet.

### RELATED APPLICATIONS

The present application claims priority to U.S. Provisional Patent Application 63/148,845, filed Feb. 12, 2021, and to U.S. Provisional Patent Application 63/157,052, filed Mar. 5, 2021, the contents of both of which are hereby incorporated by reference in their entirety.

### FIELD

The present disclosure concerns an overpressure relief system that allows for exhaust from an enclosed system once a threshold pressure is surpassed.

### BACKGROUND

Pressurized vessels are used extensively in the food and other industries. As with any pressurized vessel, however, without an overpressure relief system a buildup of excess pressure beyond safety limits can rupture or even explode such vessels. Accordingly, overpressure relief systems are a virtual requirement for the safe use of pressurized vessels in the food industry.

One common overpressure relief system is a rupture disc, which bursts at a predetermined overpressure in order to prevent catastrophic failure. While rupture discs can advantageously release overpressure, they are typically replaced after each use. Additionally, an operational shutdown is needed to replace the ruptured disc, which can cause significant processing delays.

Due to the limitations with rupture discs, pressure relief valves, which advantageously open and close in response to pressure, are commonly employed on pressure vessels. In a conventional spring-loaded pressure relief valve, a spring exerts a spring force on a seat in contact with pressure from a pressurized vessel. The spring force on the seat can be adjusted with an adjustment screw. When the seat comes in contact with an overpressure that overcomes the preset spring force, the seat lifts and allows overpressure to escape through an outlet. When sufficient overpressure is released, the spring force again becomes greater than the force exerted by the overpressure and the seat returns to seal the pressurized vessel from the surrounding environment. While spring loaded pressure relief valves solve many of the issues with rupture discs, they can require significant maintenance to remain reliable. Spring fatigue, in particular, can lead to a reduction in working performance. Accordingly, since reliability is related to the complexity of the valve, there remains a need for simple pressure relief valves that require little maintenance.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

The present disclosure concerns an overpressure relief system that allows for exhaust from an enclosed system once a threshold pressure is surpassed. In some aspects, the present disclosure concerns an overpressure relief system that includes a pressure relief channel comprising an end adapted to connect to a pressurized vessel; a shell comprising a void volume within the shell; and a moveable weight within said void volume. In some aspects, the overpressure relief system includes an outlet that is blocked by the weight or wherein access to the outlet is blocked by the weight under non-overpressure circumstances. In some aspects, the overpressure passes through the pressure relief channel toward the weight. In some aspects, the weight fills the shell in a radial direction and is moveable in an axial direction through the void volume. In some aspects, overpressure causes the weight to move into the void volume. In some aspects, the movement of the weight allows overpressure to escape from the pressurized vessel through the outlet.

In some aspects, the movement of the weight is a sliding motion. In some aspects, the axial direction is substantially parallel to a direction of gravity.

In some aspects, the overpressure is determined by the mass of the weight. In some aspects, the overpressure is in excess of 0.5 psi, optionally between 0.5 psi and 5000 psi. In further aspects, the overpressure is between 10 psi and 20 psi.

In some aspects, the overpressure relief system may include an inlet for pressurizing the pressurized vessel with a gas. In some aspects, the inlet may have a narrower width than the outlet.

In some aspects, the weight may have cylindrical in shape.

In some aspects, the shell and/or weight may include a lubricant coating to allow the weight to move through the interior of the shell. In some aspects, the lubricant is a food grade lubricant, a USP mineral oil for direct contact with food, or a synthetic isoparaffinic hydrocarbon. In some aspects, the weight may be of a metal, such as stainless steel.

In some aspects, the outlet may include a porous breather.

In certain aspects, the system excludes a spring.

In some aspects, the present disclosure concerns methods of relieving overpressure in a pressurized system through application and/or connection of the overpressure relief system through the pressure relief channel.

In some aspects, the present disclosure concerns a method for relieving overpressure in a pressurized vessel or system through contacting an overpressure from a pressurized vessel with an overpressure relief system that includes a pressure relief channel, a weight, and an outlet, wherein the outlet is blocked by the weight, wherein overpressure moves the weight in an axial direction from a first position through a void volume, wherein the movement of the weight allows overpressure to escape from said vessel through the outlet; and wherein the weight moves back to the first position after the overpressure escapes.

In some aspects, the movement of the weight is by a sliding motion. In some aspects, the axial direction is substantially parallel to a direction of gravity.

In some aspects, the pressure is between 0.5 psi and 5000 psi. In certain aspects, the pressure is between 10 psi and 20 psi.

In some aspects, the weight is cylindrical in shape. In some aspects, the weight is of a metal, such as stainless steel. In some aspects, the outlet includes a porous breather. In certain aspects, the overpressure relief system and the methods of using such excludes the inclusion or need of a spring.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals.

FIG. 1A shows a cross-sectional profile of the overpressure relief system affixed via an attached arm to the top of a vessel.

FIG. 1B shows a rotated view of a further cross-section of the overpressure relief system affixed via a clamp to the vessel.

FIG. 1C shows an aerial view of the overpressure relief system affixed to the vessel via an attached arm.

FIG. 1D shows a perspective angle of the overpressure relief system attached to the vessel via an attached arm.

FIG. 1E shows a closer view of the encircled region of FIG. 1D.

FIG. 2 shows a further cross-sectional view of the overpressure relief system where the outlet is connected directly to the pressure relief channel.

FIG. 3 shows an exterior view of the overpressure relief system detached from the vessel with option inlet connection provided.

FIG. 4A shows an aerial view of the overpressure relief system.

FIG. 4B shows the vertical cross-section of FIG. 4A.

FIG. 4C shows the horizontal cross-section of FIG. 4A.

FIG. 5A shows a profile of the weight and option components thereof of the overpressure relief system.

FIG. 5B shows a cross-sectional view of the system from FIG. 5A.

FIG. 6A shows an elevated perspective view of the base unit of the overpressure relief system.

FIG. 6B shows a lowered perspective view of the base unit of the overpressure relief system.

FIG. 6C shows an elevated rear perspective view of the base unit of the overpressure relief system.

FIG. 6D shows a lowered rear perspective view of the base unit of the overpressure relief system.

FIG. 7A shows a lowered perspective view of the shell of the overpressure relief system.

FIG. 7B shows a lowered perspective view of the lid of the shell of FIG. 7A.

### DETAILED DESCRIPTION

The present disclosure concerns overpressure relief systems and methods that require fewer parts and less maintenance. Moreover, the systems and methods do not rely on the use of a spring and, therefore, correct deficiencies with existing pressure relief valves.

As used herein, the term “shell” is defined as an encasing device that is substantially impervious to fluid flow.

As used herein, the term “radial direction” is defined as perpendicular to an axial direction. While the term radial may be related to a cross sectional shape that is circular, such is for exemplary purposes alone. Radial direction is any length across any cross sectional area independent of the shape of that area.

As used herein, the term “axial direction” is defined as perpendicular to a radial direction. While the term axial may be related to a cross sectional shape that is circular, such is for exemplary purposes alone. Axial direction is any length perpendicular to any cross sectional area independent of the shape of that area. In some aspects, an axial direction is substantially parallel to gravity.

As used herein, the term “overpressure” is defined as any pressure sufficient to move the weight in an axial direction.

As used herein, the term “pressurized vessel” is defined as any line, container, reactor, or other that is pressurized.

As used herein, the term “sliding motion” describes an object moving along in a continuous contact with a surface.

As used herein, the term “fluid” is defined as gas or liquid.

The term “overpressure” is the pressure of a fluid beyond a desired threshold. In some examples overpressure is substantially in excess of 15 pounds per square inch (psi).

An overpressure relief system for use in a pressurized vessel is provided herein. The overpressure relief system includes a shell comprising a void volume within the shell and a moveable weight within said void volume. The weight is positioned to cover or seal a pathway or pressure relief channel that is in open connection with a pressurized system and is configured such that at a desired pressure, from either gas or fluid, the weight is lifted or moved in an axial direction through the void volume when in contact with an overpressure from a pressurized vessel. The overpressure relief system also includes an outlet. The movement of the weight into the void volume and/or away from the pressure relief channel allows for the pressure relief channel to become in open communication with the outlet and thereby allows overpressure to escape from the pressurized vessel through the outlet. In some aspects, the outlet is directly connected to the pressure relief channel and a dowel extends from the weight to fill the pressure relief channel and cover the opening to the outlet. The movement of the weight into the void causes the dowel to move as well, allowing to the opening to the outlet within the pressure relief channel to be exposed and pressure to escape. The reduction of pressure then allows the weight and/or dowel to return to cover the outlet. In some aspects, the weight moves parallel or substantially parallel to the gravitational force, allowing the weight to return readily once the overpressure is exhausted.

Also provided is a method for relieving overpressure in a pressurized vessel or system. The method includes contacting an overpressure from a pressurized vessel with a weight. The overpressure moves the weight in an axial direction from a first position through a void volume. The movement of the weight allows overpressure to escape from said vessel through an outlet. The weight moves back to the first position after the overpressure is relieved by expelling a sufficient amount of fluid to bring the pressure back to within the desired tolerance.

An overpressure relief system may be used with any pressurized vessel or system. One such exemplary pressurized vessel may be a dough divider assembly as described in U.S. patent application Ser. No. 16/367,543, the entire contents of which are incorporated herein by reference. An illustrative example of an overpressure relieve system as provided herein with a dough divider is illustrated in as the vessel in the figures of this disclosure and is further described below. It will be apparent that the overpressure relief system can be adapted for any pressurized system through simply connecting the pressure relief channel as described herein to the system of choice and providing the outlet as described herein the functional capability to exhaust outside of any enclosed environment.

The present disclosure concerns an overpressure relief system that includes a pressure relief channel and an outlet fluidly connected to the pressure relief channel. The pressure relief channel provides an open or controlled path to fluidly connect the system of the present disclosure with an enclosed pressurized system. The pressure relief channel, therefore, provides a path through which the pressure of the enclosed system is connected and monitored for overpressure. The system of the present disclosure further includes a moveable weight that under non-overpressure situations closes access to an outlet, the outlet providing an exhaust for overpressure to the exterior of the system to thereby relieve and/or decrease overpressure. In instances of overpressure, the weight is moved by the pressure to allow for the fluid communication between the outlet and the pressure relief channel and effectively exhaust the overpressure. In non-overpressure instances, the weight blocks or seals the outlet from the pressure relief channel.

In some aspects, the pressure relief channel and the outlet come into open fluid communication in order to allow overpressure to exhaust from the connected systems. In some aspects, a weight controls the ability of the pressure relief channel to access the outlet. As described herein, the weight is a moveable weight that under non-overpressure conditions blocks or seals access to the outlet such that any pressure in the system less than the overpressure is substantially maintained in the system. The weight resides, at least in part, within a shell, the shell further providing a void volume within which the weight can be moved in instances where the system is experiencing overpressure. In some aspects, the weight may include flats thereon to mitigate binding. In some aspects, the weight or an attachment thereto resides in part within the pressure relief channel. In some aspects, the weight moves parallel or substantially parallel to the gravitational force, allowing the weight to return readily once the overpressure is exhausted. It will be apparent that the determination of overpressure is controlled by the pressure threshold required to move the weight. While the weight can utilize physical factors such as compression and friction to affect movability, in large part relying on mass allows for consistency as well as the ability for the system to automatically reset after overpressure is exhausted. It is therefore a further aspect of the present disclosure that the determination of “overpressure” can largely be user determined. In other words, the mass of the weight can be varied to accommodate what is required as the threshold for overpressure. In some aspects, the shell and/or weight may include a lubricant to reduce friction and/or increase reliance on the mass of the weight for determination of overpressure.

In some optional aspects, the overpressure relief system may be connected to an inlet. The inlet may be a channel by which additional items can be introduced to the overpressure relief system and/or the underlying enclosed pressurized system. In some aspects, the inlet may feed into the pressure relief channel. The inlet may be controlled by a valve, or may be disconnected and access to such closed, such as through a “quick-connect” fitting. In some aspects, the inlet may be a source of providing and/or increasing pressure to the underlying enclosed pressurized system. As the pressure relief channel is in open communication with the enclosed system, changes in pressure in the underlying enclosed system affect the overpressure relief system and equally increasing the pressure in the overpressure relief system increases pressure in the enclosed pressurized system. In some aspects, the inlet may add or adjust pressure to the collective systems, such as to establish increased pressure in the underlying enclosed pressurized system. In some aspects, adding pressure through the inlet can be counter-balanced or protected from increasing pressure over a determined threshold or overpressure through the weight selected and the ability to move such to allow for opening communication with the outlet and allowing the system to exhaust. While the inlet may be controlled in multiple ways, such as through a variable valve and/or controlled flow, in some aspects, it may optionally be considered to have the inlet feature a smaller diameter or cross-sectional width than the outlet to thereby ensure that pressure is able to exhaust faster than be introduced for additional safety purposes.

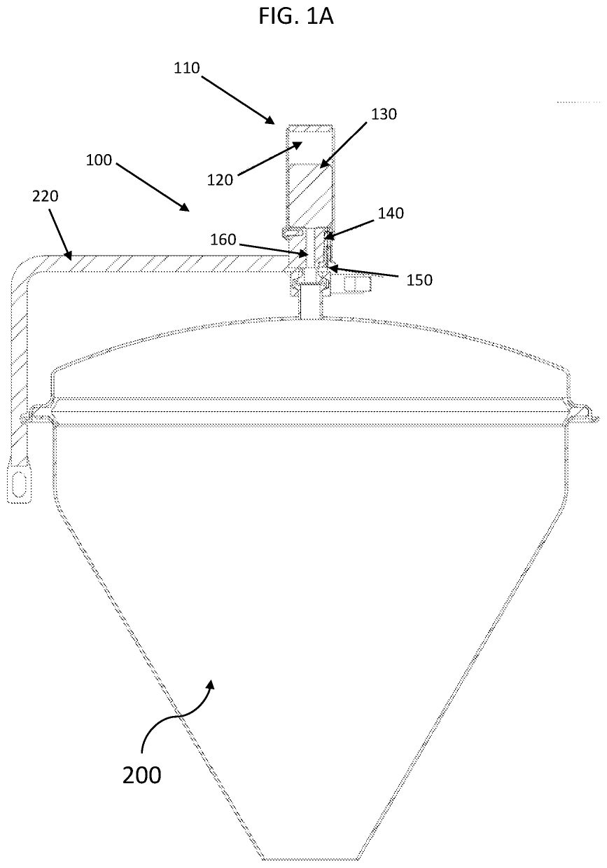

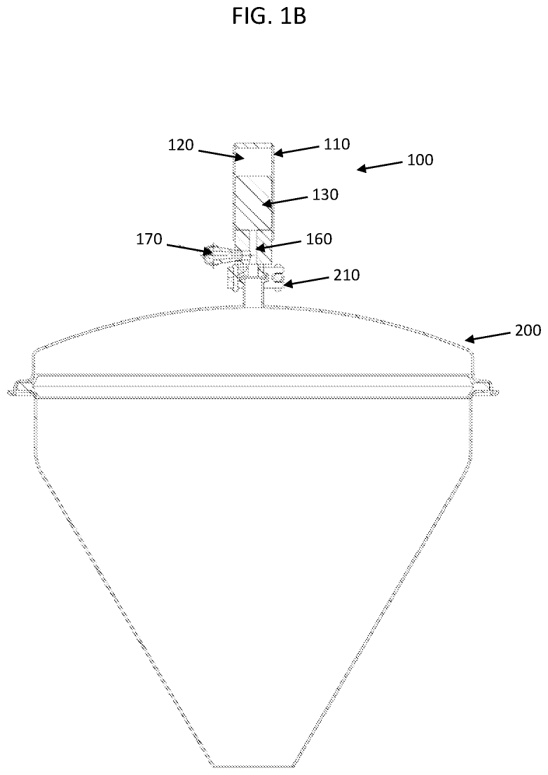

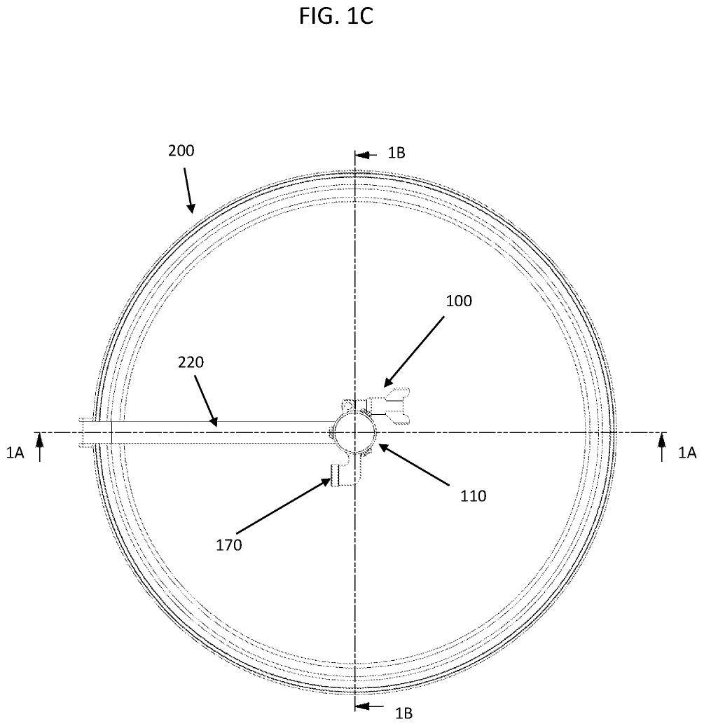

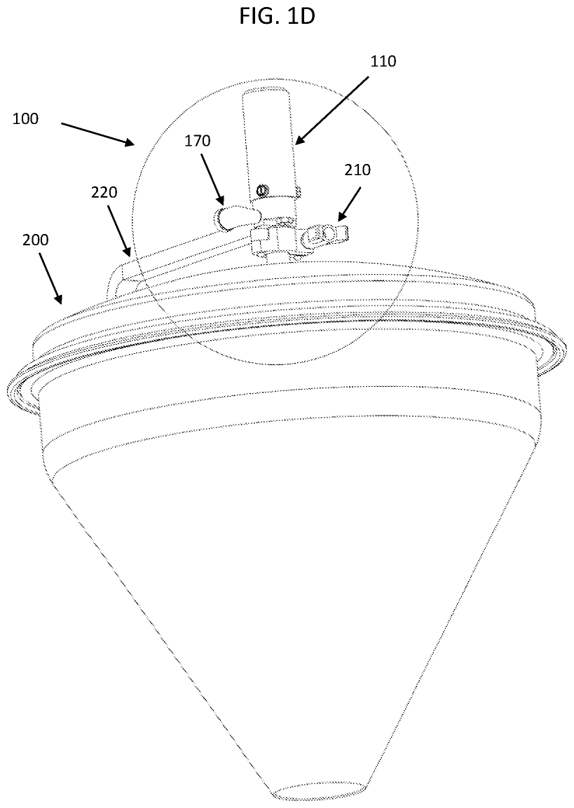

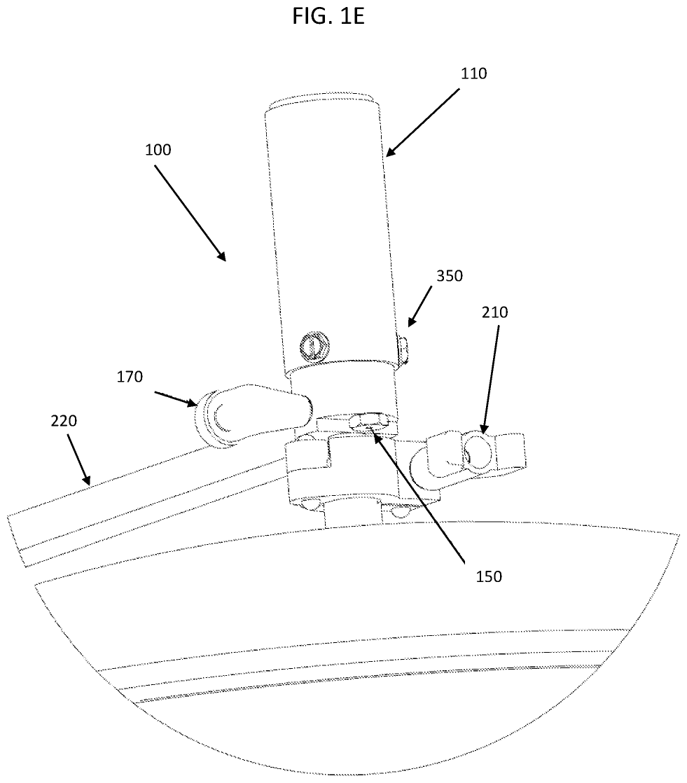

Attention is now directed to the accompanying figures. While these are presented within certain configurations, it is to be understood that the system need not be limited to replication only, but instead can be varied and adapted based on the principles of operation associated with the depicted components. FIG. 1A is a cross sectional view of overpressure relief system 100 applied to a vessel 200, such as a dough divider assembly. In some aspects, overpressure relief system 100 excludes a spring. Although the depiction of the overpressure relief system 100 with respect to the vessel 200 is illustrated as being applied to dough divider, overpressure relief system 100 may be applied to any pressurized vessel, including, without limitation, a pressure line, a reactor, or a container.

Referring to FIG. 1A, an overpressure relief system 100 may include a shell 110. Shell 110 may be made from any material that can withstand overpressure originating from a vessel 200. In some aspects, a shell 110 may be made from a plastic or a metal or metal alloy. In one or more aspects, a shell 110 is made from stainless steel. Shell 110 includes void volume 120 within the shell 110. Void volume 120 includes a moveable weight 130. Shell 110 also includes outlet 150 in fluid communication with the void volume 120 that creates an opening from void volume 120 to the outer environment. Shell 110 further includes pressure relief channel 160 so that overpressure from the vessel 200 can contact weight 130. Shell 110 is sized so that moveable weight 130 fills shell 110 in a radial direction. Shell 110 is also sized so that void volume 120 is sufficiently large to allow weight 130 to move in an axial direction through void volume 120 when in contact with overpressure from dough divider assembly 200 so that the overpressure can escape through outlet 150. Shell 110 may also be sized to accommodate weights or stacks of weights of various sizes so that overpressure relief system 100 can be easily set to the desired overpressure.

Void volume 120 is filled by weight 130 in a radial direction and provides sufficient room for weight 130 to move in an axial direction so that overpressure can escape through outlet 150. Void volume 120 may be sized to accommodate various sized weights or stacks of weights so that the overpressure relief system 100 can be easily modified. Void volume 120 may have an identical shape to weight 130 in a radial direction. For example, if weight 130 has a circular shape in the radial direction, void volume 120 will have a circular shape in the radial direction. In some aspects, void volume 120 has a cylindrical, triangular prism, or rectangular prism shape. According to one or more aspects, void volume 120 has a cylindrical shape.

Weight 130 is sized appropriately to move through void volume 120 when in contact with overpressure from dough divider assembly 200. In one or more aspects, weight 130 moves in a sliding motion. According to one or more aspects, weight 130 has a smooth surface to facilitate movement in a sliding motion. In some aspects, weight 130 moves when in contact with an overpressure of between 0.5 psi and 5,000 psi, 0.5 psi and 1,000 psi, 0.5 psi and 500 psi, 0.5 psi and 200 psi, 0.5 psi and 100 psi, 0.5 psi and 50 psi, 0.5 psi and 40 psi, 0.5 psi and 30 psi, 0.5 psi and 20 psi, 5 psi and 5,000 psi, 5 psi and 1,000 psi, 5 psi and 500 psi, 5 psi and 200 psi, 5 psi and 100 psi, 5 psi and 50 psi, 5 psi and 40 psi, 5 psi and 30 psi, 5 psi and 20 psi, 10 psi and 20 psi, or 15 psi to 20 psi. Optionally weight 130 moves with in contact with an overpressure that is a psi of 1, 2, 3, 4, 5, 6, 7, 8, 9, 10, 11, 12, 13, 14, 15, 16, 17, 18, 19, or 20. An overpressure may be any pressure over a target pressure where a target pressure is any desired pressure, optionally normal operating pressure of a vessel or for the intended use.

Weight 130 may be any shape or have at least a portion of the weight with a shape that fills shell 110 in a radial dimension and provides a barrier between pressure relief channel 160 and outlet 150 when weight 130 is not in contact with overpressure. In some aspects, weight 130 may be in the shape of a cylinder, rectangular prism, or triangular prism. According to one or more aspects, weight 130 is in the shape of a cylinder.

In some aspects, weight 130 may be sized by stacking smaller weights, all with the same or different radial dimensions, together in an axial dimension in order to set the desired overpressure. Weight 130 may be made from any material that is stable to and resists overpressure from dough divider assembly 200. In some aspects, weight 130 is made from a plastic or a metal or metal alloy. According to one or more aspects, weight 130 may be made from nickel, chromium, copper, or alloys thereof. In some aspects, weight 130 is made from stainless steel.

A seal or other system may be present surrounding the weight to help providing a slidable arrangement with the shell and/or to assist in preventing pressure escape around the sides of the weight between the weight and the shell. A seal may be any suitable material such as plastics, rubber, or other material.

When not exposed to overpressure, weight 130 may rest on pressure relief channel 160, which provides a barrier between pressure relief channel 160 and outlet 150. As such, pressure relief channel 160 may have a cross sectional area smaller than weight 130 in a radial direction. When weight 130 contacts overpressure in path 160, weight 130 moves from a first position through void volume 120, which allows fluid contact between path 160 and the outlet 150 such that overpressure may escape from dough divider 200 to outlet 150. When the overpressure has escaped, weight 130 moves back to the first position.

In some aspects, shell 110 includes a lubricant coating at least a portion of its interior. According to one or more aspects, the lubricant is a food grade lubricant, a USP mineral oil for direct contact with food, or a synthetic isoparaffinic hydrocarbon.

Outlet 150 may be any appropriate size to allow overpressure to escape. In some aspects, one end of outlet 150 is covered by weight 130 when weight 130 is not in contact with overpressure. According to one or more aspects, outlet 150 is parallel with the pressure relief channel 160. In some aspects, outlet 150 may include a porous breather 140 to limit entry of contaminants from the surrounding environment while allowing overpressure to escape. According to one or more aspects, outlet 150 may be oversized to accommodate porous breather 140. In some aspects, outlet 150 comprises a baffle.

Referring to FIG. 1B, shell 110 may further include inlet 170 for pressurizing the vessel 200 with an additional pressurized gas. Inlet 170 may be positioned so that gas is fed into the pressure relief channel between the weight 130 to the vessel 200. In some aspects, the pressurized gas may be an inert gas. According to one or more aspects, the pressurized gas is compressed air or nitrogen. In some aspects, the base of the overpressure relief system 100 may be configured such that a clamp 210 may physically attach the overpressure relief system 100 to the vessel 200.

FIG. 1C presents an aerial view of the overpressure relief system 100 atop a vessel 200. FIG. 1D sets forth a further view of the arrangement, showing the overpressure relief system 100 affixed to the vessel 200 through a clamp 210. Also depicted is an affixed arm 220 that further secures to the vessel 200. The region encircled in FIG. 1D is expanded in FIG. 1E. Both the arm 220 and the clamp 210 secure the overpressure relief system 100 in position and/or to the vessel 200. The shell 110 of the overpressure relief system 100 can be further secured to the base of the overpressure relief system 100 through a securing means 350, such as a screw that ensures that the weight will not escape or cause the shell 110 to separate from the overpressure relief system 100.

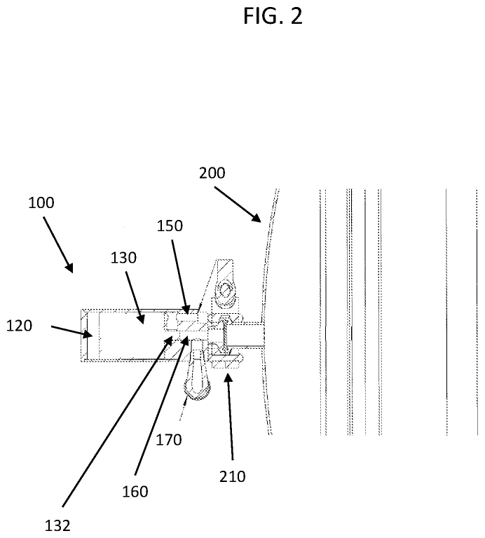

In some aspects, the outlet exhausts through the base of the overpressure relief system through the pressure relief channel. In some aspects, optionally as shown in FIG. 2, a movable weight further includes a dowel 132 that extends from the end of the weight 130 nearest the pressure relief channel 160 such that when the weight 130 is in the lowered position to prevent pressure from escaping from the vessel, the dowel 132 fills (either alone or with the addition of a seal) the pressure relief channel 160 to prevent pressure from escaping from the vessel 200. The dowel 132 is of any suitable shape to fill or substantially fill (other than a gasket or seal) the pressure relief channel 160. A dowel 132 may be a simple extension from an end of the weight 130 and may have any suitable cross sectional shape including, but not limited to circular, oval, polygon, irregular or other such shape. Optionally, a dowel 132 is a conical, triangular or other shape to sufficiently allow the weight to seat properly within the pressure escape channel 160 when in the position to prevent pressure escape from the vessel 200.

A dowel 132 has a length. The length of the dowel 132 is optionally suitable such that movement of the weight 130 from the resting position to maximum pressure release position or hitting the top of the shell 110 or other stop position does not allow the dowel 132 to be fully removed from the pressure relief channel 160 thereby retaining the weight 130 in the correct position and allowing sealing of the pressure when desired.

An outlet 150 as illustrated in FIG. 2 is optionally fluidly connected to the pressure relief channel 160, but such is for illustrative purposes only as the outlet may exit from the shell 110 instead of the pressure relief channel 160 (see, e.g. FIG. 1A). FIG. 2 is further rotated from FIGS. 1A-1E at about 90 degrees. FIG. 2 illustrates the outlet 150 exiting from the pressure relief channel 160. As depicted in FIG. 2, the outlet optionally includes two intersecting drilled holes, with the shell 110 plugging the line that is in direct communication with the pressure relief channel 160, allowing the outlet 150 to exhaust through the base of the overpressure relief system 100. When the weight 130 is in the lowered position, the entire outlet 150 may be covered by the dowel 132 within the pressure relief channel 160 such that pressure is retained within the vessel 200. When an overpressure situation is realized, the weight 130 moves away from the pressure relief channel 160 within the void volume 120 thereby moving the dowel 132 away from the opening of the outlet 150 and allowing pressure to escape from the vessel.

The overpressure relief system 100 optionally includes one or more outlets 150, optionally at the same or other positions within the shell 110 and/or the pressure relief channel 160. A system optionally includes 1, 2, 3, 4 or more outlets 150 through which pressure may be relieved by fluid flow from the system. Optionally, a system includes 2 outlets. Multiple outlets may have the same or differing shapes or sizes relative to other outlets allowing for tailored pressure relief parameters. In a further aspect, a second outlet is larger than the first outlet and is opened by further movement of the weight into the void when the first outlet cannot effectively lower the overpressure. The increased size as well as increased number of outlet can then allow the overpressure relief system to increase the exhaust of overpressure and prevent damage.

An outlet 150 is optionally defined by an opening within the shell 110 or pressure relief channel 160. An opening has a cross setional shape that is optionally circular, oval, polygon, irregular or other such shape. In some aspects, an opening in a pressure relief channel 160 is an oval optionally with the long axis substantially in line with the axis of the movement of the weight within the shell. Independent of the shape of the outlet 150, when a small amount of overpressure is realized, the weight 130 may move slightly allowing the dowel 132 to reveal only a portion of the outlet 150 and a smaller amount or rate of pressure relief to be realized. With a greater overpressure is realized, the dowel 132 is moved to reveal more of the outlet 150 such that a greater amount/rate of pressure relief is realized. When the weight 130 reaches maximum movement within the shell 110, the entire outlet 150 is optionally exposed to the pressure thereby allowing maximum pressure relief rate from the vessel 200. Other shapes may be used for the outlet 150 to achieve similar results or tailored results are desired. Optionally a triangular or other shape will also allow differing rates of pressure release with movement of the dowel 132/weight 130.

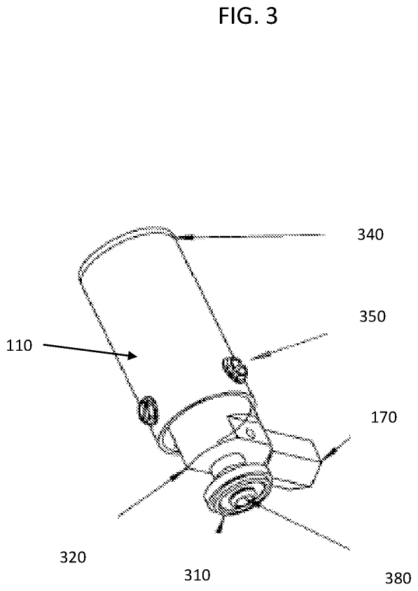

A further view of the overpressure relief system 100 is shown in FIG. 3. The overpressure relief system 100 may in some aspects feature two parts: the shell 110 and a base unit 320. The shell 110 can be attached to the base unit 320 through a securing means 350, such as a screw. The shell 110 may optionally include a lid 340. Securing the shell 110 to the base unit 320 can ensure that the shell 110 does not detach as the weight 130 (not shown in FIG. 3) rises into the void volume and potentially contacts the lid 340. The inlet 170 attaches to the base unit 320 to provide the additional flow into the vessel 200 (not shown in FIG. 3) through the pressure relief channel 160. Also shown in FIG. 3 is the bottom of the base unit 320 where a gasket 310 and a seal hanger 380 provide for a connection to the vessel 200. In some aspects, the base unit 320 can be seal clamped to the vessel 200 and or secured through an arm 220.

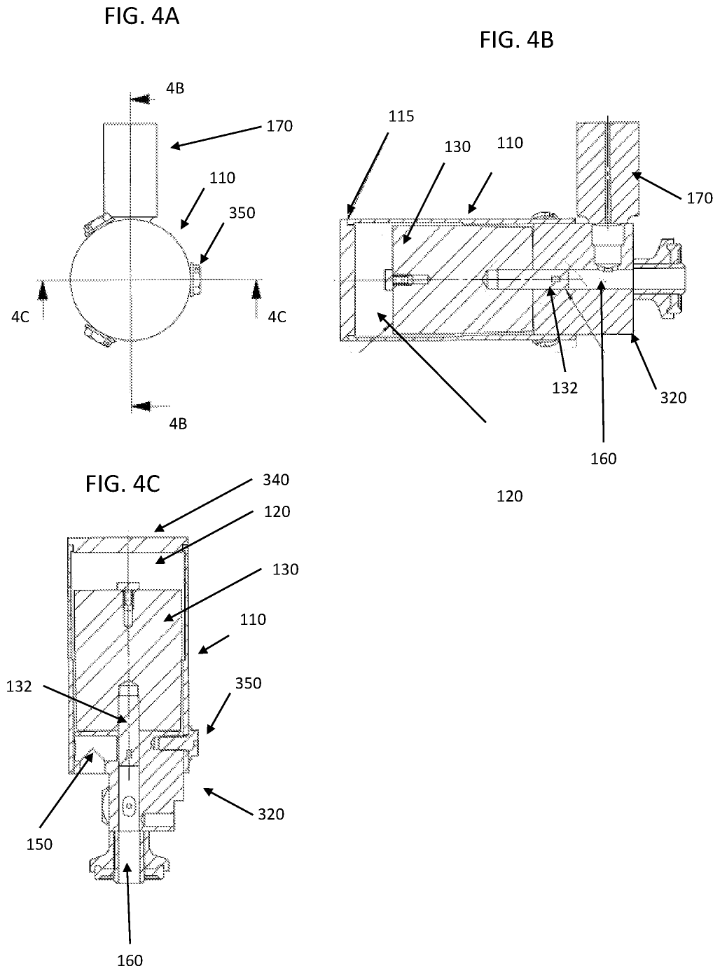

FIG. 4A shows an aerial view of the overpressure relief system, with FIG. 4B and FIG. 4C showing the marked cross sections. FIG. 4B shows a cross section of FIG. 4A that cuts through the inlet 170. The weight 130 may optionally include a dowel 132 that allows for movement within the pressure relief channel 160. FIG. 4C shows a cross section of FIG. 4A that cuts through a securing means 350. As is seen, the securing means passes through the shell 110 and embeds within the base unit 320 to secure the shell 110. The void 120 is created in the space within the shell 110 that lies beneath the lid 340. The weight 130 rests on the base unit 320 and can be pushed upwards into the void 120 of the shell 110. The diameter of the weight 130 is accordingly equal to or less than the inner diameter of the shell 110 to allow for free upward movement as pressure increases. FIG. 4C shows the outlet 150 created through two drilled portions within the base unit 320, the shell 110 plugging the exposure on the side thereof. The outlet 150 is accordingly open into the pressure relief channel 160. The positioning of the dowel 132, that is connected to or integral with the weight 130, covers the outlet 150. Increase in pressure from the vessel 200 (not shown) increases pressure within the pressure relief channel 160. With sufficient pressure accumulation, the weight will move upward into the void 120, causing the dowel 132 to slide past the opening to the outlet 150. As pressure is released from the system, the weight 130 sinks and the dowel 132 covers again the opening of the outlet 150 within the pressure relief channel 160. It is a further option that the width of the inlet 170 as it flows into the pressure relief channel 160 is narrower than the width of the outlet 150 as it exhausts in order to limit the potential for the inlet 170 to increase pressure at a higher rate than the outlet 150 can relieve overpressure.

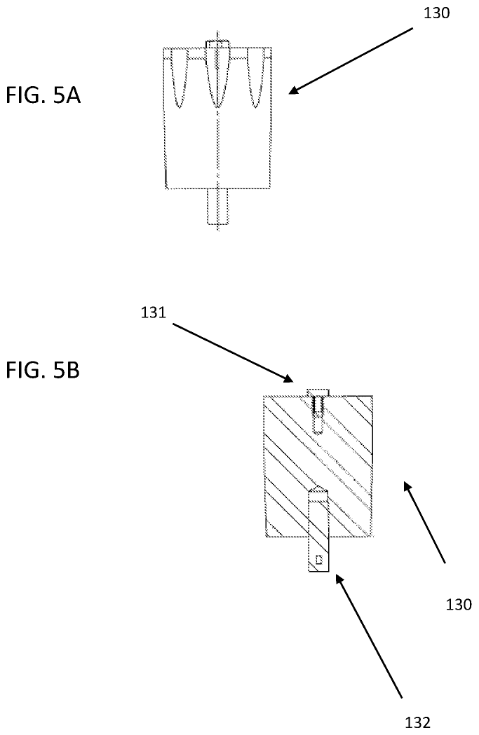

FIG. 5A shows an exterior profile of the weight 130 and FIG. 5B shows a rotated cross-section thereof. In some aspects, the weight 130 may feature tapers or to reduce the possibility of the top of the weight 130 catching or becoming stuck against the inner wall of the shell 110. FIG. 5B depicts some optional additional features of the weight 130, including a dowel 132 that it designed to fit within the pressure relief channel 160 (not shown in FIG. 5B) of the base unit 320 (not shown in FIG. 5B). The weight 130 may also optionally include a threaded screw 131, or other adjustable retaining or retarding mechanism, to provide appoint of contact with the lid 340 (not shown in FIG. 5B) of the shell 110 (not shown in FIG. 5B) and thereby prevent further movement of the weight in response to an overpressure. The screw can be adjusted to retard or extend the extent by which the weight may move inside the shell in response to an overpressure.

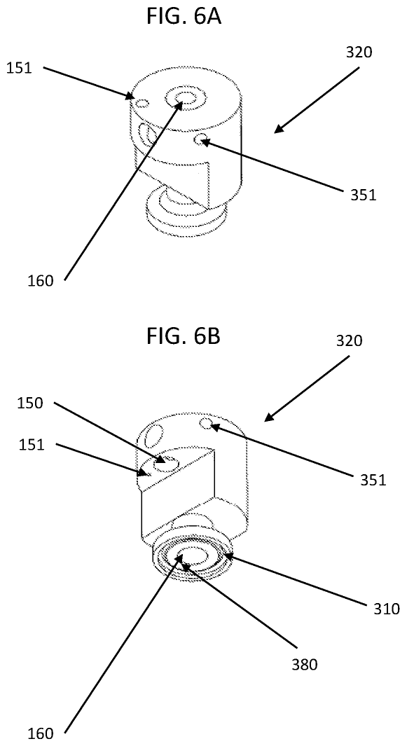

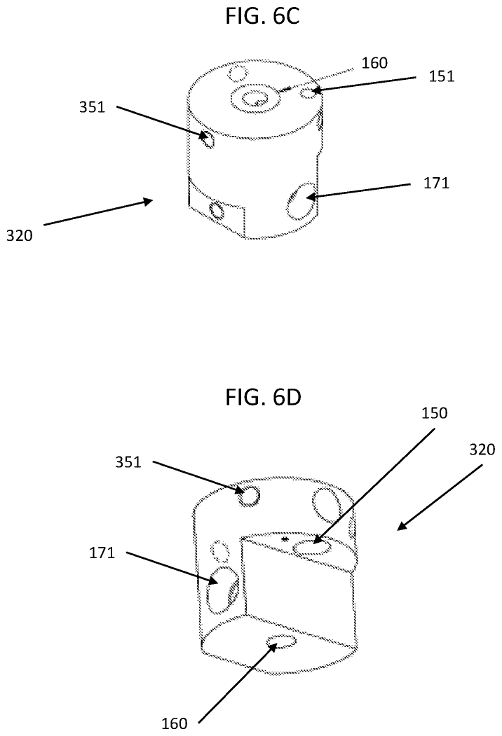

FIG. 6A shows an elevated view of an exemplary base unit 320 and FIG. 6B shows a lowered view. FIGS. 6C and 6D show the same from a rear view of the base unit. The overpressure relief system 100 may include a vent 151 that allows the system to establish an equilibrium. As seen with both views, the vent 151 can optionally taper to a smaller diameter or width on the underneath of the base unit 320. The vent 151can provide a further outlet for changes in pressure within the void volume 120 of the overpressure relief system 100, thereby ensuring that there is not a counter pressure on the weight 130 from the void volume 120. The base unit 320 may optionally feature a gasket 310 and a seal hanger 380 provides for a connection to the vessel 200 (not shown in FIGS. 6A or 6B). The base unit 320 may additionally feature one or more pre-drilled holes to allow coupling to other components. For example, the base unit 320 may include a receptacle 171 to receive the inlet 170 (not shown in FIGS. 6A or 6B). In some aspects, the receptacle 171 may include a thread to receive a bolt or screw. The base unit 320 may also include a receptacle 351 to receive the securing means 350 (not shown in FIGS. 6A or 6B). In some aspects, the receptacle 351 may include a thread to receive a bolt or screw. Also seen in FIGS. 6A and 6B is the pressure relief channel 160 that connects the vessel 200 (not shown in FIGS. 6A and 6B) to the weight 130 (not shown in FIGS. 6A or 6B) to translate pressure and lift the weight 130. In some aspects, a dowel 132 (not shown in FIGS. 6A or 6B) that is part of or connected to the weight 130 may reside within the pressure relief channel 160.

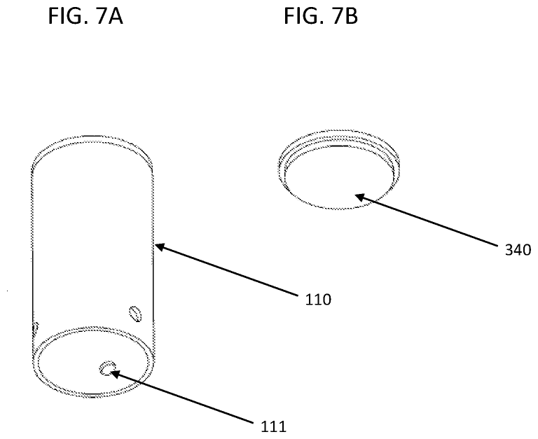

FIG. 7A shows a lowered view of the shell 110 and FIG. 7B shows the lid 340 isolated from the shell 110. The lid 340 may optionally include a lip around the circumference thereof to allow part of the lid 340 to sit within the inner diameter of the shell 110.

In some aspects, the present disclosure includes methods for using the overpressure relief system to monitor and/or detect and/or attend to overpressure in a pressurized system. By attaching or introducing the pressure relief channel into a pressurized system of either a fluid or gas, the fluid connection allows for the overpressure system to react to the pressure within the system. The selection of the mass of the weight can establish the threshold for overpressure. If the threshold is crossed, the movement of the weight engages the outlet and exhausts the overpressure, allowing the system to return to below the threshold. As the pressure drops, the ability to maintain the position of the weight drops and the weight returns to cover or block the access to the outlet and the exhaust of pressure ceases.

The forgoing description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the systems or methods are described as an order of individual steps or using specific materials, it is appreciated that steps or materials may be interchangeable such that the description of the invention may include multiple systems or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “position” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof.

We claim:

1. An overpressure relief system for use in a pressurized vessel comprising:
a pressure relief channel comprising an end adapted to connect to a pressurized vessel;
a shell comprising a void volume within the shell;
a moveable weight within said void volume, wherein at least a portion of the weight fills the shell in a radial direction and is moveable in an axial direction through the void volume when in contact with an overpressure through the pressure relief channel from the pressurized vessel; and,
an outlet;
wherein the movement of the weight allows fluid communication between the pressure relief channel and the outlet to allow overpressure to escape from the pressurized vessel through the outlet.

2. The overpressure relief system of claim 1, wherein the movement is a sliding motion.

3. The overpressure relief system of claim 1, wherein the axial direction is substantially parallel to a direction of gravity.

4. The overpressure relief system of claim 1, wherein the overpressure is in excess of 0.5 psi, optionally between 0.5 psi and 5000 psi.

5. The overpressure relief system of claim 4, wherein the overpressure is between 10 psi and 20 psi.

6. The overpressure relief system of claim 1, further comprising an inlet for pressurizing the pressurized vessel with a gas.

7. The overpressure relief system of claim 6, wherein the inlet has a narrower width than the outlet.

8. The overpressure relief system of claim 1, wherein the weight is cylindrical in shape.

9. The overpressure relief system of claim 1, wherein the shell further comprises a lubricant coating the shell's interior.

10. The overpressure relief system of claim 9, wherein the lubricant is a food grade lubricant, a USP mineral oil for direct contact with food, or a synthetic isoparaffinic hydrocarbon.

11. The overpressure relief system of claim 1, wherein the weight comprises a metal.

12. The weight of claim 10, wherein the metal comprises stainless steel.

13. The overpressure relief system of claim 1, wherein the outlet comprises a porous breather.

14. The overpressure relief system of claim 1, wherein the system excludes a spring or other elastic-based mechanism capable of returning the weight to block the outlet.

15. A method for relieving overpressure in a pressurized vessel or system comprising:
contacting an overpressure from a pressurized vessel with an overpressure relief system comprised of a pressure relief channel, a weight, and an outlet, wherein the outlet is blocked by the weight,
wherein overpressure moves the weight in an axial direction from a first position through a void volume,
wherein the movement of the weight allows overpressure to escape from said vessel through the outlet; and
wherein the weight moves back to the first position after the overpressure escapes.

16. The method of claim 15, wherein the movement is a sliding motion.

17. The method of claim 15, wherein the axial direction is substantially parallel to a direction of gravity.

18. The method of claim 15, wherein the pressure is between 0.5 psi and 5000 psi.

19. The method claim 17, wherein the pressure is between 100 psi and 200 psi.

20. The method of claim 15, wherein the weight is cylindrical in shape.

21. The method of claim 15, wherein the weight comprises a metal.

22. The method of claim 21, wherein the metal comprises stainless steel.

23. The method of claim 15, wherein the outlet comprises a porous breather.

24. The method of claim 15, wherein the method excludes a spring.
